(19) United States
(12) Patent Application Publication
(10) Pub. No.: US 2017/0067539 A1
(43) Pub. Date: Mar. 9, 2017

(54) PLANETARY GEAR SET

(71) Applicant: TOYOTA JIDOSHA KABUSHIKI KAISHA, Toyota-shi (JP)

(72) Inventors: Morihiro MATSUMOTO, Susono-shi (JP); Atsushi HONDA, Seto-shi (JP); Fusahiro TSUKANO, Susono-shi (JP)

(73) Assignee: TOYOTA JIDOSHA KABUSHIKI KAISHA, Toyota-shi (JP)

(21) Appl. No.: 15/252,882

(22) Filed: Aug. 31, 2016

(30) Foreign Application Priority Data
Sep. 3, 2015 (JP) 2015-173679
Jul. 21, 2016 (JP) 2016-143088

(51) Int. Cl. F16H 1/36; F16H 1/28

(52) U.S. Cl. CPC F16H 1/36; F16H 1/28

(57) ABSTRACT

A planetary gear set which can absorb a phase difference between gear tooth sets of a double-helical gear is provided. At least one of planetary pinions is a combined planetary pinion including a first gear piece having a predetermined helix angle, and a second gear piece having a helix angle opposite to that of the first gear piece. The first gear piece and the second gear piece are disposed on a common pinion shaft attached to a carrier while being adjacent to each other and allowed to rotate relatively to each other.

The present application claims the benefit of Japanese Patent Applications No. 2015-173679 filed on Sep. 3, 2015 and No. 2016-143088 Filed on Jul. 21, 2016 with the Japanese Patent Office, the disclosures of which are incorporated herein by reference in its entirety.

### FIELD OF THE DISCLOSURE

Embodiments of the present application relate to a planetary gear set comprising a first rotary element as a double-helical gear, and a planetary pinion that is meshed with the first rotary element.

### DISCUSSION OF THE RELATED ART

A planetary gear mechanism that has been used in a transmission for a vehicle is a differential gear mechanism which includes rotary elements such as a sun gear which is an external gear, a ring gear which is an internal gear disposed concentrically with the sun gear, and a carrier which rotatably holds a planetary pinion meshed with the sun gear and the ring gear. An example of the planetary gear mechanism has been described in US2009/0062058 A1, and a sun gear, a ring gear, and a planet pinion in the planetary transmission of the example are double-helical gears. In a double-helical gear, two sets of gear teeth are formed with mutually oppositely directed helices so that the axial force component or thrust forces developed at each mesh on the double-helical gear have equal magnitude and opposite direction. In the planetary transmission taught by US2009/0062058 A1, the thrust force component on each gear set of planet pinion gear set of planet pinion is cancelled within the respective planet pinion by the thrust force component developed at the other gear set on the respective planet pinion. Therefore, substantially no unbalanced net thrust force component is present on any planet pinion and the carrier. According to the teachings of US2009/0062058 A1, therefore, it is not necessary to provide a trust bearing with the planet pinion.

Since the helical gear includes two sets of gear teeth formed with mutually oppositely directed helices across a center groove, the helical gear is not allowed to be meshed with the other gear in an axially sliding fashion. Whereas, in the planetary transmission taught by US2009/0062058 A1, the ring gear is also formed in two parts such as a first annular portion formed with the first internal gear set and a second annular portion formed with the second internal gear set so that the double-helical planet pinions can be inserted into the ring gear from both sides in the axial direction while being meshed therewith. However, given that the gear sets of the ring gear are out of phase, the planetary pinions inserted into the ring gear from both sides in the axial direction on a common rotary shaft may not be rotated smoothly. As a result, one of the gear sets may not be allowed to be involved in torque transmission. Further, the gears may suffer from wearing out while generating noise. In order to eliminate such problems, if an attempt is made to provide an adjustor mechanism to adjust the relative phases of gear sets in a double-helical gear, an arrangement of the planetary gear set may be complicated and hence an assemble work may become difficult.

### SUMMARY

The present application has been made in view of the abovementioned technical problems, and it is therefore an object of the present application is to provide a planetary gear set, in which a planetary pinion is divided into a plurality of pieces to absorb a phase difference between gear tooth sets of a double-helical gear meshed with the planetary pinion such as a ring gear or a sun gear.

In order to achieve the object, according to embodiments of the present application, there is provided a planetary gear set having at least three rotary elements, comprising: a first rotary element including two sets of gear teeth formed with mutually oppositely directed helices; a plurality of planetary pinions arranged in a circular manner; and a second rotary element that supports the planetary pinions in a rotatable and revolvable manner. In the planetary gear set, the planetary pinions include at least one combined planetary pinion including a first gear piece having a predetermined helix angle, and a second gear piece having a helix angle opposite to that of the first gear piece. In addition, the first gear piece and the second gear piece are supported by the second rotary element while being allowed to rotate relatively to each other.

In a non-limiting embodiment, the planetary gear set may further comprise a stopper portion that prevents an isolation of the first gear piece and the second gear piece of the combined planetary pinion in the axial direction.

In a non-limiting embodiment, one of the first gear piece and the second gear piece may include a cylindrical portion that extends toward the other of the first gear piece and the second gear piece in such a manner as to be fitted onto a pinion shaft attached to the second rotary element in a rotatable manner, and the other of the first gear piece and the second gear piece may be fitted onto the cylindrical portion.

In a non-limiting embodiment, the stopper portion may include a flange member attached to a leading end of the cylindrical portion.

In a non-limiting embodiment, the planetary gear set may further comprise a third rotary element that is disposed concentrically with the first rotary element, and that includes two sets of gear teeth formed with mutually oppositely directed helices.

In a non-limiting embodiment, the planetary pinions may include a first planetary pinion meshing with the first rotary element, and a second planetary pinion meshing with the first planetary pinion and the third rotary element, and at least one of the first planetary pinion and the second planetary pinion may include the combined planetary pinion.

In a non-limiting embodiment, the planetary gear set may further comprises a fourth rotary element. In addition, the second gear piece may include a plurality of sets of gear teeth, and one of the sets of gear teeth is meshed with the first rotary element, and another one of the sets of gear teeth is meshed with the fourth rotary element.

In a non-limiting embodiment, the planetary gear set may further comprise a fifth rotary element. In addition, the first gear piece may be meshed with another gear meshed with the first rotary element and the fifth rotary element.

In a non-limiting embodiment, the planetary pinion may include a stepped planetary pinion including a diametrically smaller portion and a diametrically larger portion.

In a non-limiting embodiment, the first gear piece and the second gear piece may be disposed on a pinion shaft attached to the second rotary element while being adjacent to each other and allowed to rotate relatively to each other.

Thus, according to the embodiments of the present application, at least one of the planetary pinions is divided into the first gear piece and the second gear piece on a common pinion shaft while being allowed to rotate relatively to each other. According to the embodiments of the present application, therefore, a phase error between the gear teeth sets of the sun gear or the ring gear meshed with the combined pinion gear can be absorbed by a relative rotation between the first gear piece and the second gear piece of the combined planetary pinion. For this reason, noises and damages on the double helical gears forming the planetary gear set can be limited to lessen abrasion of the double helical gears.

In addition to the above-explained advantages, according to the non-limiting embodiment, an isolation between the first gear piece and the second gear piece in the axial direction caused by a thrust load applied to the combined planetary pinion during operation of the planetary gear set can be restricted by the stopper portion attached to the leading end of the cylindrical portion formed on any one of the first gear piece and the second gear piece. Further, number of the bearings interposed between the combined planetary pinion and the pinion shaft can be reduced.

In addition, the combined planetary pinion may be used not only in a single-pinion planetary gear set but also in a double-pinion planetary gear set, a Ravigneaux planetary gear set and a stepped-pinion planetary gear set. Further, since an isolation between the first gear piece and the second gear piece can be restricted by the stopper portion, friction between a lateral face of the gear piece and an inner face of the carrier can be reduced so that a power loss in the planetary gear set can be reduced.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a schematic illustration showing a first embodiment of the present application;

FIG. 2 is a cross-sectional view along a line II-II in the embodiment in FIG. 1;

FIG. 3 is a cross-sectional view showing a second embodiment in which the combined planetary pinion is provided with a stopper portion that restricts an isolation of the first gear piece and the second gear piece;

FIG. 4 is a schematic illustration showing a third embodiment in which the combined planetary pinion is used in a double-pinion planetary gear set;

FIG. 5 is a perspective view showing an example of a structure of a Ravigneaux planetary gear set according to a fourth embodiment;

FIG. 6 is a cross-sectional view along a line IV-IV in FIG. 5;

FIG. 7 is a cross-sectional view showing a modification of the fourth embodiment in which the combined planetary pinion is provided with a stopper portion that restricts an isolation of the first gear piece and the second gear piece;

FIG. 8 is a cross-sectional view showing a fifth embodiment in which the combined planetary pinion is a stepped planetary pinion; and

FIG. 9 is a cross-sectional view showing a modification of the fifth embodiment in which the combined planetary pinion is provided with a stopper portion that restricts an isolation of the first gear piece and the second gear piece.

### DETAILED DESCRIPTION OF THE PREFERRED EMBODIMENTS

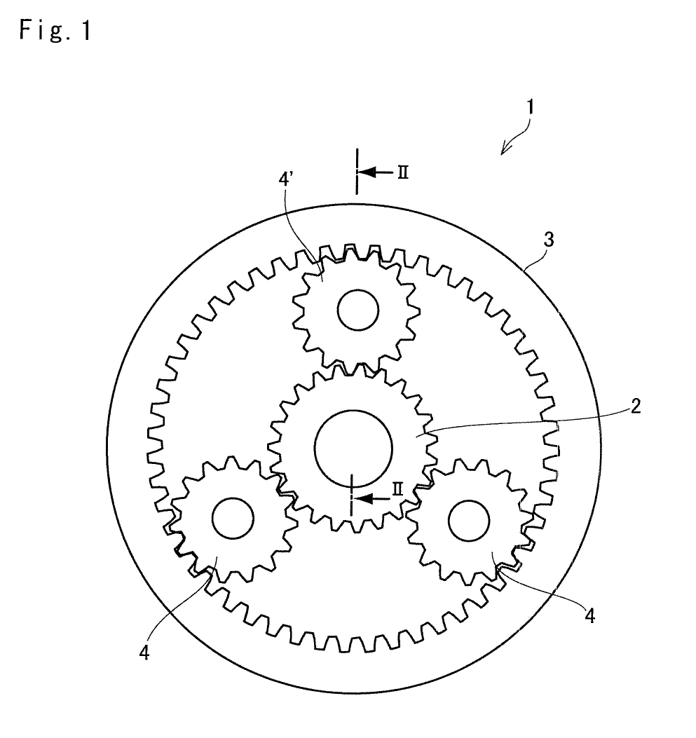

A first embodiment of a planetary gear set according to the present application will now be described with reference to FIG. 1. FIG. 1 is a schematic illustration showing a planetary gear set 1 in the embodiment. The planetary gear set 1 is a single-pinion planetary gear set comprising three rotary elements. Specifically, the planetary gear set 1 comprises a sun gear 2 formed around a rotary shaft 13, a ring gear 3 disposed concentrically on an outer circumferential side of the sun gear 2, a carrier 6 including pinion shafts 5, and planetary pinions 4 fitted onto the pinion shafts 5 in a rotatable and revolvable manner. In the example illustrated in FIG. 1, three planetary pinions 4 are disposed at a predetermined interval in a circumferential direction.

In the planetary gear set 1, at least any one of the planetary pinions 4 is divided into two gear pieces while being allowed to rotate relatively to each other on the pinion shaft 5. In the embodiment illustrated in FIG. 1, specifically, the planetary pinion 4 at an upper side in FIG. 1 is divided into two gear pieces and will be referred to as the “combined planetary pinion 4” in the following description. The remaining planetary pinions 4 are conventional double helical gear comprising two sets of gear teeth formed with mutually oppositely directed helices.

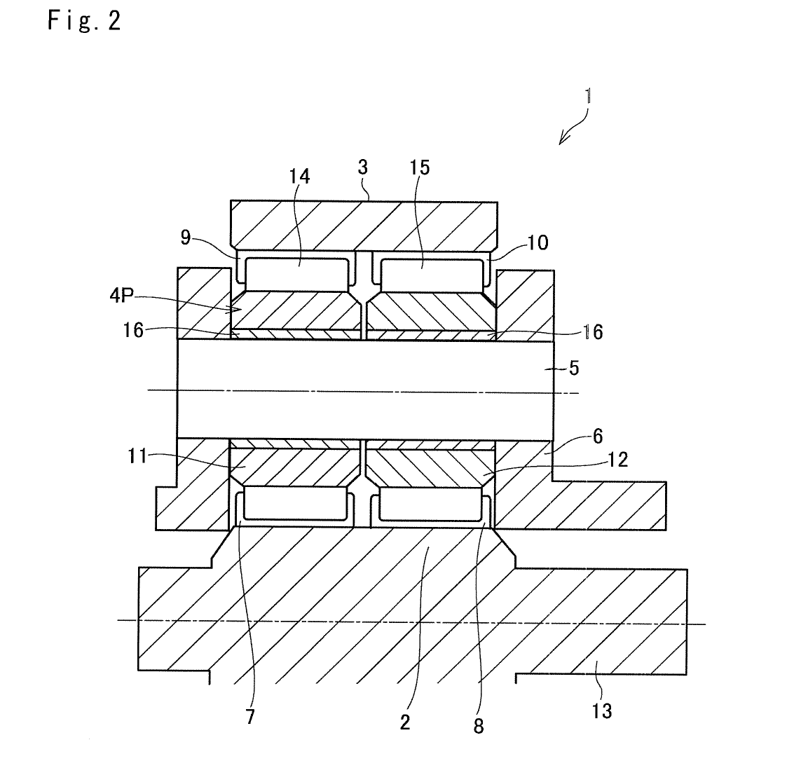

Also, each of the sun gear 2 and the ring gear 3 always meshing with the planetary pinions 4 is individually a conventional double helical gear in which an axial force component is cancelled. Specifically, the double helical gear used as the sun gear 2 and the ring gear 3 includes two sets of gear teeth formed with mutually oppositely directed helices. As illustrated in FIG. 2, first outer teeth 7 and second outer teeth 8 meshing with the planetary pinion 4 are formed on an outer circumference of the sun gear 2. Whereas, first inner teeth 9 and second inner teeth 10 meshing with the planetary pinions 4 are formed on an inner circumference of the ring gear 3. The helix angle refers to an angle between: a line of intersection between a pitch surface and a tooth flank; and a rotational axis of the gear.

The combined planetary pinion 4′ includes a first gear piece 11 and a second gear piece 12 fitted onto the common pinion shaft 5 while being adjacent to each other through bearings 16 so that the first gear piece 11 and the second gear piece 12 are allowed to rotate relatively to each other. That is, the first gear piece 11 and the second gear piece 12 are combined on the common pinion shaft 5 to form the double helical combined planetary gear 4′.

Specifically, first outer teeth 14 are formed on the first gear piece 11, and second outer teeth 15 are formed on the second gear piece 12. Each of the first outer teeth 14 and the second outer teeth 15 are helical teeth with a predetermined helix angle, and the first outer teeth 14 and the second outer teeth 15 are mutually oppositely directed. The first outer teeth 14 of the first gear piece 11 are meshed with the first outer teeth 7 of the sun gear 2 and the first inner teeth 9 of the ring gear 3, and the second outer teeth 15 of the second gear piece 12 are meshed with the second outer teeth 8 of the sun gear 2 and the second inner teeth 10 of the ring gear 3. Accordingly, one of the sun gear 2 and the ring gear 3 serves as the first rotary element, the carrier 6 serves as the second rotary element, and the other of the sun gear 2 and the ring gear 3 serves as the third rotary element.

An assembling method of the planetary gear set 1 according to the embodiment will be explained hereinafter. First of all, the planetary pinions 4 are arranged around the sun gear 2 in such a manner that the outer teeth of each of the planetary pinions 4 are individually meshed with the outer teeth 7 and 8 of the sun gear 2, while being held by a jig or the like. A unit of the planetary pinions 4 and the sun gear 2 thus engaged is then inserted into the ring gear 3 in such a manner that the outer teeth of the planetary pinions 4 are individually meshed with the inner teeth 9 and 10 of the ring gear 3. Then, the first gear piece 11 of the combined planetary pinion 4′ is inserted between the sun gear 2 and the ring gear 3 while meshing the first outer teeth 14 of the first gear piece 11 with the first outer teeth 7 of the sun gear 2 and the first inner teeth 9 of the ring gear 3 from one of the axial directions, and the second gear piece 12 of the combined planetary pinion 4′ is inserted between the sun gear 2 and the ring gear 3 while meshing the second outer teeth 15 of the second gear piece 12 with the second outer teeth 8 of the sun gear 2 and the second inner teeth 9 of the ring gear 3 from axially opposite direction. Thereafter, the pinion shafts 5 are individually inserted into the combined planetary pinion 4′ and the planetary pinions 4, and one of front or rear members of the carrier 6 is attached to one ends of the pinion shafts 5 and the other of the front or rear member of the carrier 6 is attached to the other end of the pinion shafts 5. According to the embodiment, therefore, the planetary gear set 1 having double helical gears can be assembled easily without requiring a complicated additional assembling tools and a large assembling site.

In the planetary gear set 1, the gear teeth sets of the sun gear 2 or the ring gear 3 may be out of phase due to machining error or an assembling error. According to the embodiment, since the first gear piece 11 and the second gear piece 12 of the combined planetary pinion 4′ are allowed to rotate relatively to each other, such phase error between the gear teeth sets of the sun gear 2 or the ring gear 3 meshed with the combined pinion gear 4′ in a rotational direction can be absorbed by a relative rotation between the first gear piece 11 and the second gear piece 12 of the combined planetary pinion 4′. Specifically, if the first outer teeth 7 and the second outer teeth 8 of the sun gear 2 are out of phase, such phase error may be absorbed by a relative rotation between the first gear piece 11 and the second gear piece 12 of the combined planetary pinion 4′. Likewise, if the first inner teeth 9 and the second inner teeth 10 of the ring gear 3 are out of phase, such phase error may also be absorbed by a relative rotation between the first gear piece 11 and the second gear piece 12 of the combined planetary pinion 4′. Consequently, each tooth flank of the first outer teeth 14 of the first gear piece 11 can be brought into contact properly with each tooth flank of the first outer teeth 7 of the sun gear 2 or each tooth flank of the first inner teeth 9 of the ring gear 3. Likewise, each tooth flank of the second outer teeth 15 of the second gear piece 12 can be brought into contact properly with each tooth flank of the second outer teeth 8 of the sun gear 2 or each tooth flank of the second inner teeth 10 of the ring gear 3. For this reason, noises and damages on the double helical gears forming the planetary gear set 1 can be limited to lessen abrasion of the double helical gears.

As described, in the combined planetary pinion 4′, the first outer teeth 14 of the first gear piece 11 and the second outer teeth 15 of the second gear piece 12 are mutually oppositely directed. During operation of the planetary gear set 1, the first gear piece 11 and the second gear piece 12 of the combined planetary pinion 4′ may be isolated away from each other on the pinion shaft 5 by a thrust load applied to the first outer teeth 14 of the first gear piece 11 and the second outer teeth 15 of the second gear piece 12 from radially outer side. Consequently, the first gear piece 11 and the second gear piece 12 may be brought into contact to the inner lateral faces of the carrier 6 to cause a power loss resulting from friction between the gear piece 11 and 12 and the carrier 6.

According to the example shown in FIGS. 1 and 2, thrust loads are applied to the combined planetary pinion 4′ by the ring gear 3 and the sun gear 2 from axially opposite directions. Consequently, a play between the pinion shaft 5 and the bearing 16 is reduced by a torque applied to any of the rotary element of the planetary gear set 1 and hence the first gear piece 11 and the second gear piece 12 are inclined with respect to the rotary shaft 13. If the first gear piece 11 or the second gear piece 12 is thus inclined, engagement condition between the sun gear 2 or the ring gear 3 and the first gear piece 11 and the second gear piece 12 is changed, and consequently the thrust load applied to the first gear piece 11 or the second gear piece 12 from the sun gear 2 or the ring gear 3 is also changed. That is, if the thrust load applied to the first gear piece 11 or the second gear piece 12 from any one of the sun gear 2 and the ring gear 3 overwhelms the thrust load applied to the first gear piece 11 or the second gear piece 12 from the other of the sun gear 2 and the ring gear 3, the first gear piece 11 or the second gear piece 12 is inclined in any of the axial directions.

Given that a tapered roller bearing is used as the bearing 16 to support the combined planetary pinion 4′, rolling members of the tapered roller bearing are skewed with respect to the rotary shaft 13 by such inclination of the combined planetary pinion 4′. Such skew of the tapered roller bearing is changed depending on the play between the pinion shaft 5 and the bearing 16, and the combined planetary pinion 4′ is also subjected to a thrust load resulting from such skew of the bearing 16.

A direction of the above-mentioned thrust loads may be calculated based on a direction of the torque applied to the rotary member of the planetary gear set 1. According to the example shown in FIGS. 1 and 2, therefore, a helix angle of the first gear piece 11 and a helix angle of the second outer teeth 15 of the second gear piece 12 are individually set in such a manner that the thrust loads applied to the first gear piece 11 and the second gear piece 12 counteract to each other. For this reason, the first gear piece 11 and the second gear piece 12 are kept to be contacted to each other on the pinion shaft 5.

Thus, the thrust loads applied to the combined planetary pinion 4′ can be cancelled to each other by merely adjusting the helix angles of the first gear piece 11 and the second outer teeth 15 without requiring an additional member such as a thrust bearing. According to the example shown in FIGS. 1 and 2, therefore, the planetary gear set 1 can be downsized. In addition, since the thrust loads applied to the combined planetary pinion 4′ can be cancelled to each other, friction between each of the first gear piece 11 and the second gear piece 12 and the inner face of the carrier 6 can be reduced so that a power loss in the planetary gear set 1 can be reduced.

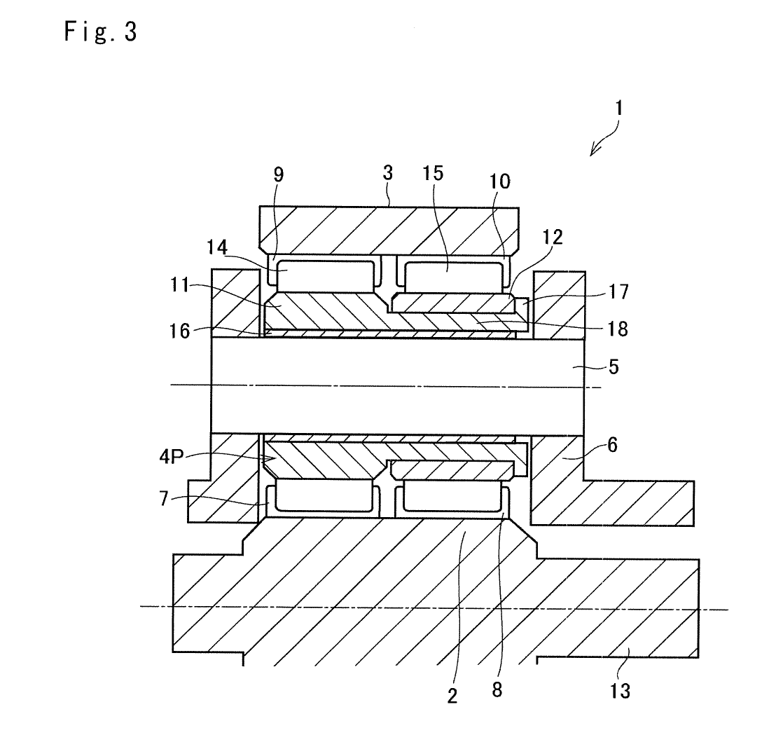

Turning to FIG. 3, there is shown a second embodiment in which such isolation of the first gear piece 11 and the second gear piece 12 is prevented. According to the second embodiment, the combined planetary pinion 4′ is further provided with a cylindrical portion 18 extending from the first gear piece 11 toward the second gear piece 12, and a stopper portion 17 as a flange portion that is attached to a leading end of the cylindrical portion 18. Specifically, a length of the cylindrical portion 18 is identical to or slightly longer than a thickness of the second gear piece 12, and an inner diameter of the second gear piece 12 is identical to or slightly larger than an outer diameter of the cylindrical portion 18. In this case, the second gear piece 12 is fitted onto the cylindrical portion 18 of the first gear piece 11 that is already fitted onto the pinion shaft 5 while being allowed to rotate relatively to the first gear piece 11, and then the stopper portion 17 is attached to the leading end of the cylindrical portion 18 by any appropriate method such as a caulking method. Alternatively, given that the cylindrical portion 18 is formed to have a length longer than the thickness of the second gear piece 12, a nut or a snap ring may also be fitted onto the leading end of the cylindrical portion 18 to serve as the stopper portion 17. According to the second embodiment, therefore, the stopper portion 17 is brought into contact to a lateral face of the second gear piece 12 when the first gear piece 11 and the second gear piece 12 are isolated away from each other on the pinion shaft 5 by the thrust load during operation of the planetary gear set 1. That is, components of the thrust load acting on the first gear piece 11 and the second gear piece 12 in axially opposite directions can be cancelled by an internal force acting between the lateral face of the second gear piece 12 and the stopper portion 17. Here, it is to be noted that the cylindrical portion 18 may also be formed in the second gear piece 12 in such a manner as to extend toward the first gear piece 11.

Thus, according to the second embodiment, separation of the first gear piece 11 and the second gear piece 12 in the axial direction is restricted by the stopper portion 17. That is, the second gear piece 12 can be prevented from being contacted to an inner face of the carrier 6. For this reason, friction between the lateral face of the second gear piece 12 and the inner face of the carrier 6 can be reduced so that a power loss in the planetary gear set 1 can be reduced. Here, since the second gear piece 12 is allowed to rotate relatively to the first gear piece 11 within a range of phase difference between the gear sets of the sun gear 2 or the ring gear 3, the second gear piece 12 and the cylindrical portion 18 are rotated at substantially same speeds and hence a power loss in the planetary gear set 1 will not be caused by a sliding resistance between the lateral face of the second gear piece 12 and the inner face of the stopper portion 17. Likewise, a sliding resistance between an inner circumferential face of the second gear piece 12 and an outer circumferential face of the stopper portion 17 will not be a cause of a power loss in the planetary gear set 1.

In addition, number of the bearings 16 can be reduced in comparison with the first embodiment illustrated in FIG. 2. That is, according to the second embodiment, the cylindrical portion 18 of the first gear piece 11 serves as a base member of the second gear piece 12, and hence only one bearing 16 is required to support the combined planetary pinion 4′. For this reason, a manufacturing cost of the planetary gear set 1 can be reduced.

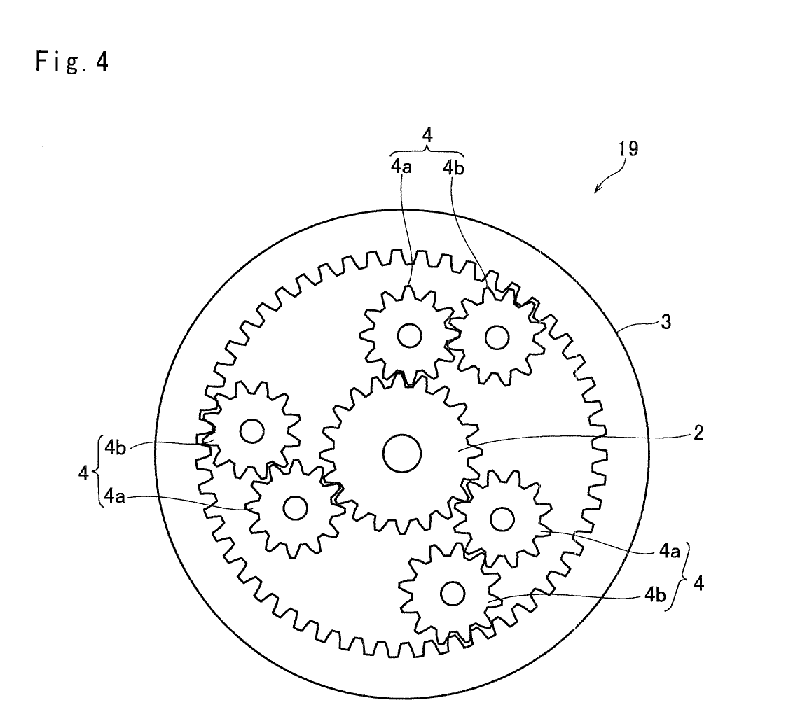

Turning to FIG. 4, there is shown a third embodiment of the present application. The combined planetary pinion 4′ comprising the first gear piece 11 and the second gear piece 12 according to the first embodiment and the second embodiment may also be applied to a double-pinion planetary gear set. As illustrated in FIG. 4, the double-pinion planetary gear set 19 comprises: the sun gear 2 formed around a rotary shaft, a plurality of inner planetary pinions 4a arranged around the sun gear 2 while being meshed therewith, the ring gear 3 arranged concentrically with the sun gear 2, and a plurality of outer planetary pinions 4b arranged between the inner planetary pinions 4a and the ring gear 3 while being meshed with the inner planetary pinions 4a and the ring gear 3. In this case, the combined planetary pinion 4′ may be used as at least one of the inner planetary pinions 4a and the outer planetary pinions 4b. Accordingly, the inner planetary pinion 4a corresponds to the claimed first planetary pinion, and the outer planetary pinion 4b corresponds to the claimed second planetary pinion.

Here will be explained an assembling method of the double-pinion planetary gear set 19 according to the third embodiment. Given that the combined planetary pinion 4′ is used individually as one of the inner planetary pinions 4a and one of the outer planetary pinions 4b meshing with each other, the inner planetary pinions 4a, the outer planetary pinions 4b, the first gear piece 11 of the combined planetary pinion 4′ serving as the inner planetary pinion 4a, and the first gear piece 11 of the combined planetary pinion 4′ serving as the outer planetary pinion 4b are arranged between the sun gear 2 and the ring gear 3. Then, pinion shafts 5 are individually inserted into the planetary pinions 4a, 4b and the first gear pieces 11, and the second gear piece 12 of the combined planetary pinion 4′ serving as the inner planetary pinion 4a, and the second gear piece 12 of the combined planetary pinion 4′ serving as the outer planetary pinion 4b are fitted onto the pinion shafts 5 from axially opposite side of the first gear pieces 11. Thereafter, one of the front and rear members of the carrier 6 is attached to one ends of the pinion shafts 5 and the other of the front or rear member of the carrier 6 is attached to the other end of the pinion shafts 5.

Alternatively, given that the combined planetary pinion 4′ is used as any one of the inner planetary pinion 4a and the outer planetary pinion 4b in one of the pairs of the inner planetary pinion 4a and the outer planetary pinion 4b meshing with each other, the inner planetary pinions 4a, the outer planetary pinions 4b, and the first gear piece 11 of the combined planetary pinion 4′ serving as the inner planetary pinion 4a or the outer planetary pinion 4b are arranged between the sun gear 2 and the ring gear 3. Then, pinion shafts 5 are individually inserted into the planetary pinions 4a, 4b, and the first gear piece 11, and the second gear piece 12 of the combined planetary pinion 4′ serving as the inner planetary pinion 4a or the outer planetary pinion 4b are fitted onto the pinion shaft 5 from axially opposite side of the first gear piece 11. Thereafter, one of the front and rear members of the carrier 6 is attached to one ends of the pinion shafts 5 and the other of the front or rear member of the carrier 6 is attached to the other end of the pinion shafts 5.

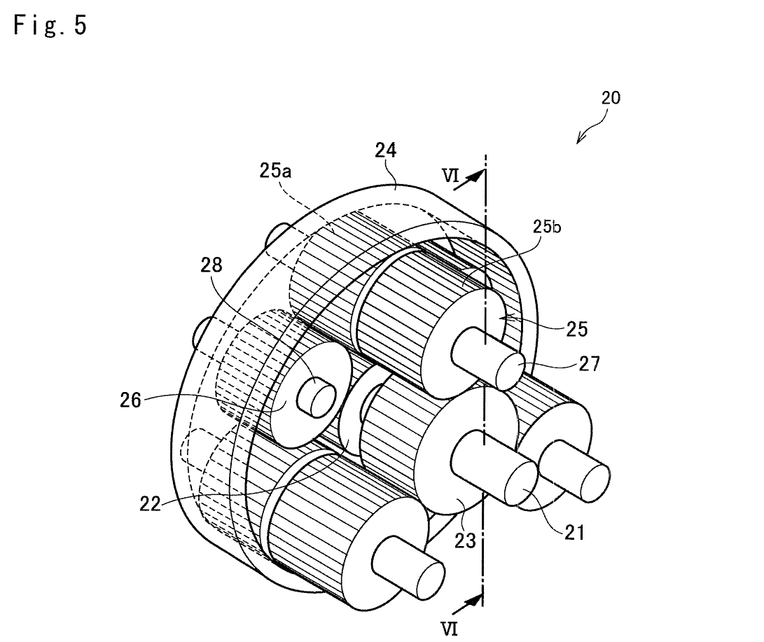

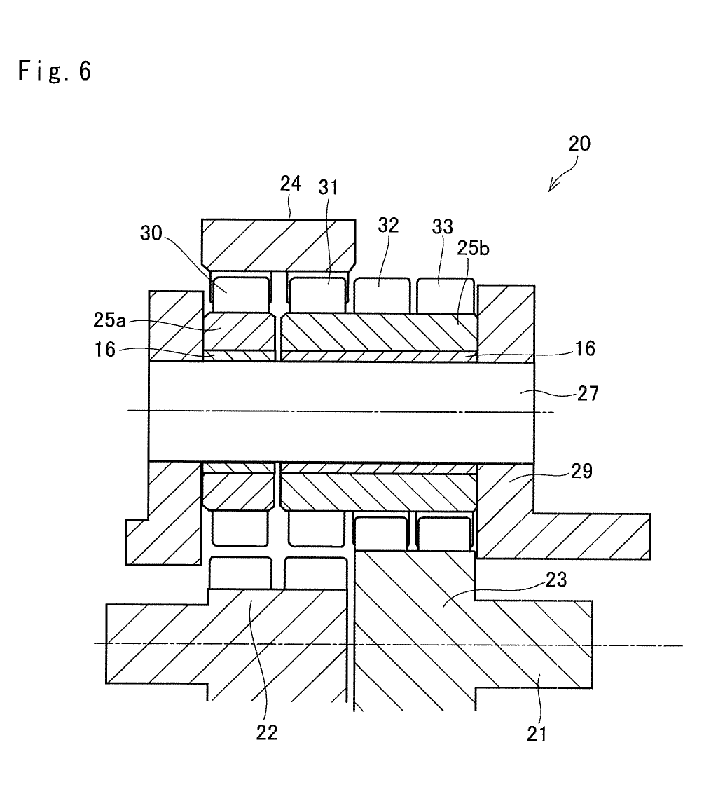

Next, a fourth embodiment of the present application will be explained with reference to FIGS. 5 and 6. FIG. 5 shows a Ravigneaux planetary gear set 20 formed by combining a single-pinion planetary gear set and a double-pinion planetary gear set. Specifically, in the Ravigneaux planetary gear set 20, a diametrically-smaller front sun gear 22 and a diametrically larger a rear sun gear 23 are formed around a rotary shaft 21 while being adjacent to each other, and a ring gear 24 is arranged coaxially with the rotary shaft 21. A plurality of long planetary pinions 25 are interposed between the rear sun gear 23 and the ring gear 24 while being meshed individually therewith, and a plurality of short planetary pinions 26 are arranged alternately with the long planetary pinions 25 in a circumferential direction while being meshed individually with the front sun gear 22 and the long planetary pinion 25. The long planetary pinions 25 are individually supported by long pinion shafts 27 while being allowed to rotate thereon, and the short planetary pinions 26 are individually supported by short pinion shafts 28. Each ends of the long pinion shafts 27 and the short pinion shafts 28 are connected to a front member of carrier 29 and a rear member of the carrier 29. That is, in the Ravigneaux planetary gear set 20, the ring gear 24 and the carrier 29 are used commonly in the single-pinion planetary gear set and the double-pinion planetary gear set.

In the fourth embodiment, at least one of the long planetary pinions 25 is divided into a first gear piece 25a and a second gear piece 25b, and the first gear piece 25a and the second gear piece 25b are allowed to rotate relatively to each other on the long pinion shaft 27. Specifically, the first gear piece 25a is provided with first outer teeth 30, and the second gear piece 25b is provided with second outer teeth 31, third outer teeth 32 and fourth outer teeth 33. The first gear piece 25a is fitted onto the long pinion shaft 27 on the left side in FIG. 6 and the second gear piece 25b is fitted onto the long pinion shaft 27 on the right side in FIG. 6. That is, the first outer teeth 30 of the first gear piece 25a and the second outer teeth 31 of the second gear piece 25b are meshed with the inner teeth of the ring gear 24, and the third outer teeth 32 and the fourth outer teeth 33 of the second gear piece 25b are meshed with the outer teeth of the rear sun gear 23. In the fourth embodiment, accordingly, the ring gear 24 serves as the first rotary element, the carrier 29 serves as the second rotary element, the rear sun gear 23 serves as the fourth rotary element, the front sun gear 22 serves as the fifth rotary element, and the long planetary pinion 25 serves as the combined planetary pinion.

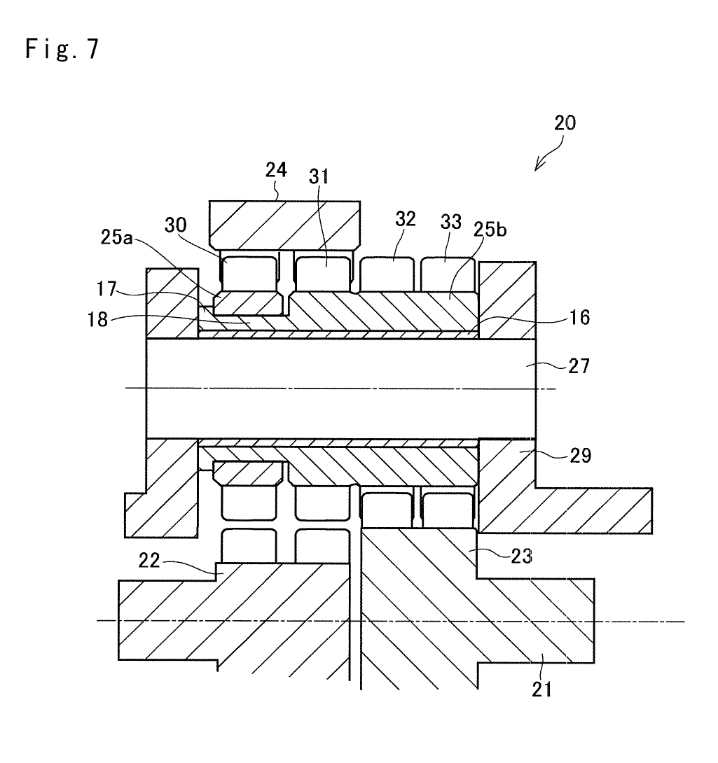

An assembling method of the Ravigneaux planetary gear set 20 according to the fourth embodiment will be explained hereinafter. First of all, the short planetary pinions 26 are arranged around the front sun gear 22 while being meshed therewith, and the long planetary pinions 25 and the second gear piece 25b are arranged around the rear sun gear 23 while being meshed therewith. Then, the short pinion shafts 28 are individually inserted into the short planetary pinions 26, and the long pinion shafts 27 are individually inserted into the long planetary pinions 25 and the second gear piece 25b. Thereafter, the first gear piece 25a is fitted onto the long pinion shaft 27 from axially opposite side of the second gear piece 25b while being meshed with the inner teeth of the ring gear 24. Thereafter, one of the front and rear members of the carrier 29 is attached to one ends of the pinion shafts 27 and 28, and the other of the front or rear member of the carrier 29 is attached to the other end of the pinion shafts 27 and 28. Optionally, as shown in FIG. 7, the aforementioned stopper portion 17 may also be formed on a leading end of the cylindrical portion 18 of the first gear piece 25a or the second gear piece 25b. In the example shown in FIG. 7, specifically, the cylindrical portion 18 extends from the second gear piece 25b toward the first gear piece 25a, and the stopper portion 17 is attached to the leading end of the cylindrical portion 18. In this case, the Ravigneaux planetary gear set 20 may be assembled by the method similar to the assembling method of the planetary gear set 1 according to the second embodiment.

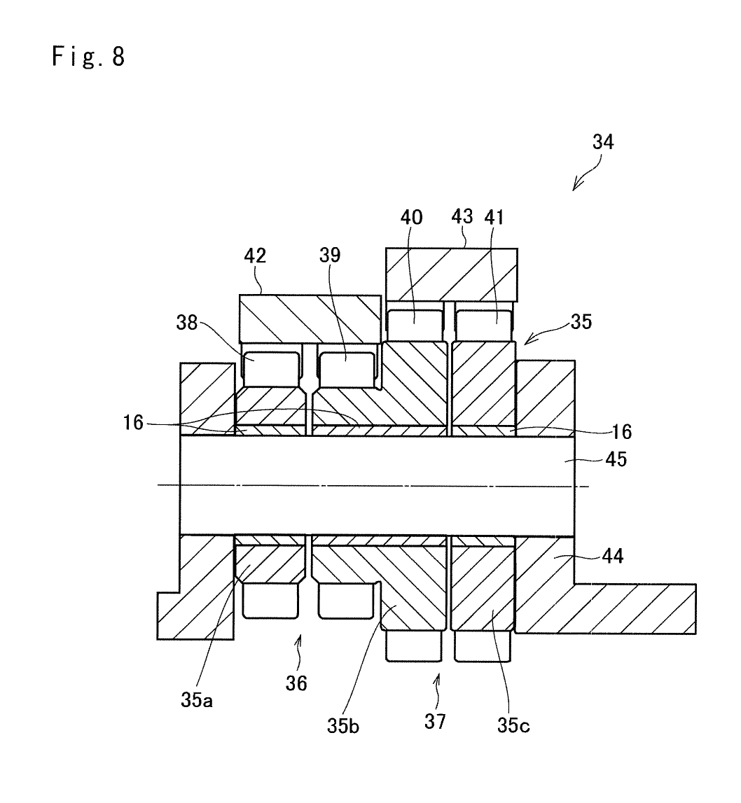

Turning to FIG. 8, there is shown a fifth embodiment of the present application in which the combined planetary pinion according to the present application applied to a so-called stepped-pinion planetary gear set 34. As illustrated in FIG. 8, a stepped planetary pinion 35 includes a diametrically smaller portion 36 and a diametrically larger portion 37. Specifically, the stepped planetary pinion 35 is fitted onto a pinion shaft 45 in a rotatable manner through the bearing 16, and both ends of the pinion shaft 45 are attached to a front member and a rear member of a carrier 44. In the stepped planetary pinion 35, the diametrically smaller portion 36 is provided with first outer teeth 38 and second outer teeth 39 meshing with inner teeth of a first ring gear 42, and the diametrically larger portion 37 is provided with third outer teeth 40 and fourth outer teeth 41 meshing with inner teeth of a second ring gear 43. According to the fifth embodiment, the stepped planetary pinion 35 is divided into a first gear piece 35a, a second gear piece 35b and a third gear piece 35c, and those gear pieces 35a, 35b and 35c are allowed to rotate relatively to each other on the pinion shaft 45. Although the stepped planetary pinion 35 is thus divided into three pieces in the fifth embodiment, number of pieces forming the stepped planetary pinion 35 may be changed arbitrarily according to need. For example, the stepped planetary pinion 35 may also be divided into two pieces not only in the diametrically smaller portion 36 but also in the diametrically larger portion 37. The stepped-pinion planetary gear set 34 is allowed to multiply transmission torque while reducing a speed by halting the carrier 44 to use the first ring gear 42 as an input element and to use the second ring gear 43 as an output element. In the fifth embodiment, accordingly, one of the first ring gear 42 and the second ring gear 43 serves as the first rotary element, the carrier 44 serves as the second rotary element, the other of the first ring gear 42 and the second ring gear 43 serves as the fourth rotary element, and the stepped planetary pinion 35 serves as the combined planetary pinion.

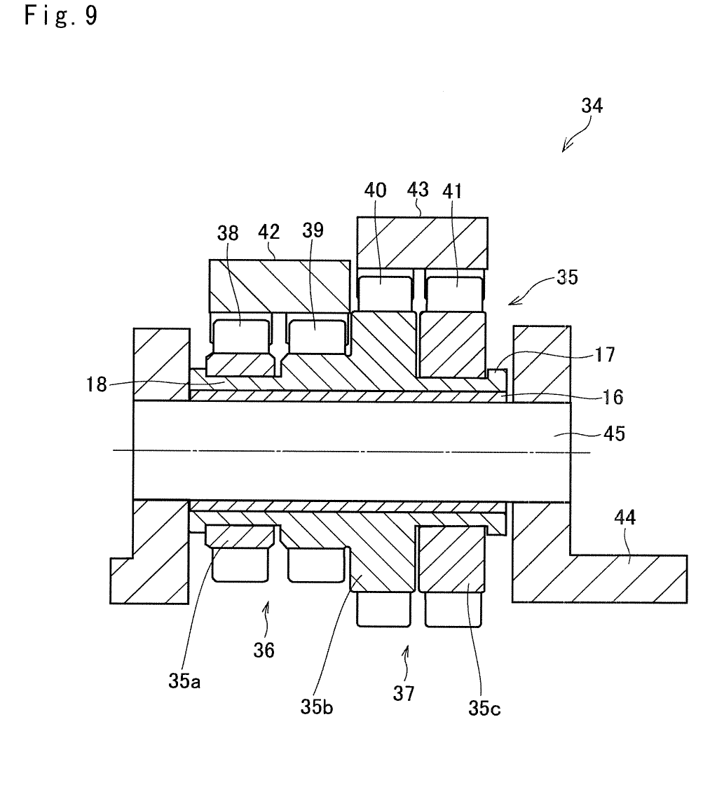

An assembling method of the stepped-pinion planetary gear set 34 according to the fourth embodiment will be explained with reference to FIG. 8. First of all, the first gear piece 35a of the diametrically smaller portion 36 of the stepped planetary pinion 35 is fitted onto the pinion shaft 45, and the first ring gear 42 is fitted onto the first gear piece 35a from one of the axial directions while meshing the inner teeth thereof with the first outer teeth 38 of the first gear piece 35a. Then, the second gear piece 35b is fitted onto the pinion shaft 45 from the axially opposite side while meshing the second outer teeth 39 with the inner teeth of the first ring gear 42, and the second ring gear 43 is fitted onto the second gear piece 35b from said one of the axial direction while meshing the inner teeth thereof with the third outer teeth 40. Thereafter, the third gear piece 35c is fitted onto the pinion shaft 45 from the axially opposite side while meshing the fourth outer teeth 41 with the inner teeth of the second ring gear 43, and the front member and the rear member of the carrier 44 are fitted onto both ends of the pinion shaft 45. Optionally, as shown in FIG. 9, the aforementioned stopper portion may also be formed in the second gear piece 35b of the stepped planetary pinion 35. In this case, the cylindrical portion 18 may be formed on the inner circumferential portion of the second gear piece 35b, and the stopper portion 17 may be formed on at least one of the leading ends of the cylindrical portion 18. In this case, the stepped-pinion planetary gear set 34 may also be assembled by the method similar to the assembling method of the planetary gear set 1 according to the second embodiment.

In the Ravigneaux planetary gear set 20 and the stepped-pinion planetary gear set 34, a phase error in the double helical gear meshed with the combined planetary pinion due to machining error or an assembling error can be absorbed by a relative rotation of the combined planetary pinion 4. For this reason, noises and damages on the double helical gears forming the planetary gear sets 20 or 34 can be limited to lessen abrasion of the double helical gears.

It is understood that the invention is not limited by the exact construction of the foregoing embodiments, but that various modifications may be made without departing from the spirit of the inventions. For example, the number of planetary pinions in the planetary gear sets may be altered according to need.

What is claimed is:

1. A planetary gear set having at least three rotary elements, comprising:
a first rotary element including two sets of gear teeth formed with mutually oppositely directed helices;
a plurality of planetary pinions arranged in a circular manner; and
a second rotary element that supports the planetary pinions in a rotatable and revolvable manner,
wherein the planetary pinions include at least one combined planetary pinion including a first gear piece having a predetermined helix angle, and a second gear piece having a helix angle opposite to that of the first gear piece, and
wherein the first gear piece and the second gear piece are supported by a the second rotary element while being allowed to rotate relatively to each other.

2. The planetary gear set as claimed in claim 1, further comprising:
a stopper portion that prevents an isolation of the first gear piece and the second gear piece of the combined planetary pinion in the axial direction.

3. The planetary gear set as claimed in claim 2, wherein
one of the first gear piece and the second gear piece includes a cylindrical portion that extends toward the other of the first gear piece and the second gear piece in such a manner as to be fitted onto the pinion shaft attached to the second rotary element in a rotatable manner, and
the other of the first gear piece and the second gear piece is fitted onto the cylindrical portion.

4. The planetary gear set as claimed in claim 1, wherein
one of the first gear piece and the second gear piece includes a cylindrical portion that extends toward the other of the first gear piece and the second gear piece in such a manner as to be fitted onto the pinion shaft attached to the second rotary element in a rotatable manner,
the other of the first gear piece and the second gear piece is fitted onto the cylindrical portion, and
the stopper portion includes a flange member attached to a leading end of the cylindrical portion.

5. The planetary gear set as claimed in claim 1, further comprising:
a third rotary element that is disposed concentrically with the first rotary element, and that includes two sets of teeth formed with mutually oppositely directed helices.

6. The planetary gear set as claimed in claim 5, wherein
the planetary pinions include a first planetary pinion meshing with the first rotary element, and a second planetary pinion meshing with the first planetary pinion and the third rotary element, and
at least one of the first planetary pinion and the second planetary pinion includes the combined planetary pinion.

7. The planetary gear set as claimed in claim 1, further comprising:
a fourth rotary element, wherein
the second gear piece includes a plurality of sets of gear teeth,
one of the sets of gear teeth is meshed with the first rotary element, and another one of the sets of gear teeth is meshed with the fourth rotary element.

8. The planetary gear set as claimed in claim 7, further comprising:
a fifth rotary element, wherein
the first gear piece is meshed with another gear meshed with the first rotary element and the fifth rotary element.

9. The planetary gear set as claimed in claim 7, wherein the planetary pinion includes a stepped planetary pinion including a diametrically smaller portion and a diametrically larger portion.

10. The planetary gear set as claimed in claim 1, wherein the first gear piece and the second gear piece are disposed on a pinion shaft attached to the second rotary element while being adjacent to each other and allowed to rotate relatively to each other.
